(19) United States
(12) Patent Application Publication
(10) Pub. No.: US 2026/0163340 A1
(43) Pub. Date: Jun. 11, 2026

(54) Seismic Dampener For High Voltage Insulator Assembly

(71) Applicant: Southern States LLC, Hampton, GA (US)

(72) Inventors: Joseph Andreyo, Fayetteville, GA (US); Joseph R Rostron, McDonough, GA (US); John William Popovits, Stockbridge, GA (US)

(21) Appl. No.: 18/969,491

(22) Filed: Dec. 5, 2024

(51) Int. Cl. H02B 1/54; F16F 7/00

(52) U.S. Cl. CPC H02B 1/54; F16F 7/00; F16F 2224/0208; F16F 2224/025; F16F 2228/007

(57) ABSTRACT

A seismic dampener for a high voltage insulator assembly includes a top plate, a bottom plate, and an alternating series of relatively high modulus (hard) layers and relatively low modulus (elastomeric) layers compressed between the top plate and the bottom plate, which may be configured as an integrated cartridge for convenient installation. The seismic dampener is installed inline with an insulator supporting an equipment load at an elevated location between the insulator and a stand supporting the insulator. For example, the seismic dampener may be located at a height that is at least one-half the height of the insulator. Each relatively low modulus layer may include ethylene propylene diene monomer (EPDM) rubber about ¼-inch thick, and each relatively high modulus layer may include stainless steel about ⅛-inch thick. Example seismic dampeners have three elastomeric layers, five elastomeric layers, or seven elastomeric layers.

### TECHNICAL FIELD

This invention relates to high voltage electric power systems and, more particularly, to a seismic dampener including an alternating series of relatively high modulus layers and relatively low modulus layers located inline with an insulator at an elevated location within a high voltage insulator assembly.

### BACKGROUND

Like all terrestrial structures, the electrical power grid is subject to potential damage from seismic shaking caused by earthquakes. Many high voltage substations include heavy switching equipment, such as disconnect switches, circuit breakers and bus insulators, supported by long insulators fabricated from fragile materials, such as porcelain. For high voltage safety reasons, the insulators are mounted on tall stands, which increases the shaking moment between the equipment load on top of the insulator and the foundation at the bottom of the stand making these structures particularly vulnerable to seismic damage. Earthquake damage to high voltage insulators at substations can take entire transmission and distribution power lines out of service disrupting electric power service to critical industries and systems.

IEEE Standard 693-2018 provides recommended practices for seismic testing and design of substation equipment. A variety of conventional earthquake dampening systems have been applied to high voltage insulator structures since the 1970's with varying degrees of success. For example, hydraulic, pneumatic and spring dampeners have been installed between concrete foundations and the base of the stands. These dampeners typically extend both vertically and horizontally away from the stand requiring multiple dampeners to absorb different modes of seismic energy. This is an expensive approach as multiple dampeners extending in different directions are required to absorb different modes of seismic energy. Even with multiple dampeners, this approach only provides limited improvement due to the long bending moment between the base of the stand, where the dampeners are installed, and the equipment loads connected to the top of the insulators.

As another option, diagonal insulators have been connected between insulators. This approach only provides limited improvement, however, as a diagonal insulator only mitigates seismic shaking in the direction of the diagonal insulator, while seismic shaking can occur in any direction. As a result, conventional approaches to seismic mitigation for high voltage substations are costly, requiring significantly heavier insulators, a large number of costly dampeners, and complicated seismic absorber systems. There is an ongoing need for more robust and cost-effective approaches to reduce seismic damage to high voltage insulator assemblies.

### SUMMARY

The needs described above are met in a seismic dampener that includes an alternating series of relatively high modulus layers and relatively low modulus layers sandwiched between a top plate and a bottom plate. The seismic dampener may further include fasteners securing the layers together into an integrated cartridge for convenient installation, including new assemblies and retrofit installation at existing substations. The seismic dampener is located at an elevated position in a high voltage insulator assembly, for example inline with an insulator supporting an equipment load between the base of the insulator and an insulator mounting surface of a stand supporting the insulator. The seismic dampener thus provides a hinge in the bending moment between the foundation experiencing the seismic shaking and the equipment load at the top of the insulator significantly reducing the strain on the fragile insulator.

In a representative embodiment, the relatively low modulus layers may be ethylene propylene diene monomer (EPDM) rubber about ¼-inch thick, and the relatively high modulus layers may be stainless steel about ⅛-inch thick. The top plate may be galvanized steel plate about ¾-inch thick, and the bottom plate may be galvanized steel plate about 1-inch thick.

In another representative embodiment, a seismic dampened high voltage insulator assembly includes an insulator and a seismic dampener including an alternating series of relatively high modulus layers and relatively low modulus layers sandwiched between a top plate and a bottom plate. An equipment mount on an upper end of the insulator supports an equipment load, and the insulator further includes a lower end having an insulator base. A stand extends from a foundation to an insulator mounting surface. The seismic dampener is located inline with the insulator at an elevated location in the insulator assembly between the insulator base and the insulator mounting surface of the stand. In a representative embodiment, the height of the seismic dampener above the foundation may be at least one-half the height of the insulator.

It will be understood that specific embodiments may include a variety of features in different combinations, and that all of the features described in this disclosure, or any particular set of features, need not be included in a particular embodiment. The specific techniques and structures for implementing particular embodiments of the invention and accomplishing the associated advantages will become apparent from the following detailed description of the embodiments and the appended drawings and claims.

### BRIEF DESCRIPTION OF THE FIGURES

The numerous advantages of the invention may be better understood with reference to the accompanying figures in which:

FIG. 1 is a front view of an insulator assembly including a seismic dampener positioned between an insulator base and an insulator mounting surface.

FIG. 2 is a perspective view of the insulator assembly.

FIG. 3 is a partially exploded view of the insulator assembly.

FIG. 4 is a conceptual illustration of shaker table testing of an insulator.

FIG. 5 is a partially exploded view including a first example seismic dampener.

FIG. 6 is a front view including the first example seismic dampener.

FIG. 7 is a perspective view including the first example seismic dampener.

FIG. 8 is an exploded view including the first example seismic dampener.

FIG. 9 is an exploded view including a second example seismic dampener.

FIG. 10 is a front view including the second example seismic dampener.

FIG. 11 is a perspective including the second example seismic dampener.

FIG. 12A is a top view of a top plate of a seismic dampener.

FIG. 12B is a perspective view of the top plate.

FIG. 13A is a top view of a ring-type elastomeric layer of a seismic dampener.

FIG. 13B is a perspective view of the ring-type elastomeric layer.

FIG. 14A is a top view of a sheet-type elastomeric layer of a seismic dampener.

FIG. 14B is a perspective view of the sheet-type elastomeric layer.

FIG. 15A is a top view of a metallic layer of a seismic dampener.

FIG. 15B is a perspective view of the metallic layer.

FIG. 16A is a top view of a bottom plate of a seismic dampener.

FIG. 16B is a perspective view of the bottom plate.

### DESCRIPTION OF ILLUSTRATIVE EMBODIMENTS

Embodiments of the invention include seismic dampeners for high voltage insulator assemblies. The dampener includes an alternating series of relatively high modulus layers and relatively low modulus layers. For example, the relatively high modulus layers may be metallic, such as stainless steel, and the relatively low modulus layers may be elastomeric, such as ethylene propylene diene monomer (EPDM) rubber. The seismic dampener may be configured as an integrated cartridge for convenient installation inline with an insulator at an elevated position in the insulator assembly, for example between the base of the insulator and a stand supporting the insulator.

Like all terrestrial structures, the electrical power grid is subject to earthquakes, which can disrupt service to critical industries and systems. The reliability of the power supply system can be compromised by failure of insulator assemblies that support heavy electrical equipment, such as high voltage disconnect switches, circuit breakers and bus insulators. Insulators supporting the disconnect switches and circuit breakers include long columns of fragile materials, such as porcelain, subject to damage and failure due to the extreme shaking caused by earthquakes. For high voltage safety reasons, the insulators are mounted on tall stands, which increases the shaking moment between the equipment load at the top of the insulator and the foundation making these structures particularly vulnerable to seismic damage. Earthquake damage to high voltage insulators at substations can take entire transmission and distribution power lines out of service disrupting electric power service to critical industries and systems.

Rather than the conventional approaches of strengthening the insulator materials and applying multiple dampeners at the base of the stand, the present invention changes the nature of how the insulator assembly responds to seismic shaking forces resulting in more robust designs less susceptible to the high forces at lower costs with higher reliability. More specifically, a relatively small, horizontally symmetric seismic dampener about the same diameter as the insulator is inserted inline with the insulator at an elevated position in the insulator assembly, for example between the base of the insulator and the stand. The seismic dampener includes an alternating series of relatively low modulus of elasticity (elastomeric) layers (e.g., EPDM rubber) and relatively high modulus of elasticity (hard) layers (e.g., stainless steel) to absorb seismic energy through friction, which avoids the use of more complicated and costly hydraulic, pneumatic or spring mechanisms. While EPDM is a suitable low modulus material, other elastomeric materials may be utilized, such as nylon, urethane, etc. Similarly, while stainless steel is a suitable high modulus material, other similarly hard materials may be used, such as other metals, glass, ceramic, composites, etc.

This configuration produces a number of benefits. As the seismic dampener is only a few inches tall in the vertical direction, it can be inserted into an existing insulator assembly without making additional changes to the assembly. This allows the seismic dampener to be inserted into an existing insulator assembly as a retrofit modification without otherwise altering the existing insulator assembly. This presents a tremendous opportunity for cost savings as the seismic damper can be added to existing switches, breakers, bus supports, and other substation equipment as a retrofit modification to increase the reliability and seismic rating of the entire substation. As a result, the utility does not have to completely rebuild a substation to obtain the improved seismic capability. Similarly, the seismic dampener can be inserted into the new insulator assemblies without otherwise altering the standard insulator design.

In addition, the horizontally symmetrical design of the dampener positioned inline with the insulator simultaneously absorbs all modes of seismic shaking propagating to the insulator. Positioning the dampener at an elevated location in the insulator assembly is beneficial as the ground shaking motion causes a rigid insulator assembly to have more motion than the ground itself. The rigidity of the insulator assembly is mitigated by locating the dampener at an elevated position in the insulator assembly, such as between the top of the stand and the base of the insulator, providing a hinge in the middle of the insulator structure. The seismic dampener provides flexibility between the stand and the base of the insulator supporting the heavy equipment load, which significantly reduces the bending moment between the foundation and the equipment load while also allowing for higher amplification of the shaking motion due to flexing at the elevated dampener. The elevated position of the dampener thus reduces the stress on the insulator significantly compared to a rigid insulator assembly with the dampener located at the base of the stand near the concrete foundation.

The innovative seismic dampener avoids the use of fluids or liquids, which are subject to corrosion and leakage. Instead, the elastomeric (relatively low modulus) layers under high compression become thinner and expand wider causing sliding friction between the elastomer and the thin metallic (relatively high modulus) plates. This friction is the mechanism for generating seismic dampening as it absorbs the energy, thus eliminating any need for complicated hydraulic cylinder solutions. In addition, the elastomeric dampening action provides very little spring back once the load is removed. The number of the elastomeric layers of this sandwich, the thickness of the elastomer layers, and their durometer can be varied to achieve different force profiles and seismic dampening characteristics. The rocking motion of the insulator relative to the stand causes opposing sides of the dampener to be compressed alternately. As the solution is symmetric, this action does not depend on the rotation of the forces and ground motion as the dampener automatically responds similarly to all seismic shaking orientations.

In an illustrative embodiment, the seismic dampener is located inline with the insulator at an elevated position in a high voltage insulator assembly, for example between the base of an insulator and an insulator mounting surface of a stand supporting the insulator. The relatively low modulus layers may be ethylene propylene diene monomer (EPDM) rubber about ¼-inch thick, and the relatively high modulus layers may be stainless steel about ⅛-inch thick. The top plate may be galvanized steel plate about ¾-inch thick, and the bottom plate may be galvanized steel plate about 1-inch thick. The compact size and shape of the seismic dampener allows it to be conveniently installed inline with the insulator at an elevated position in the insulator assembly, providing a hinge in the bending moment between the foundation at the bottom of the stand and the equipment load at the top of the insulator. The seismic dampener is symmetric about multiple horizontal axes, allowing it to simultaneously absorb all modes of seismic energy avoiding the need for multiple dampeners extending in different horizontal directions.

The seismic dampener may include rings, sheets, or other shapes of elastomeric material, as a matter of design choice. As insulators for higher voltages are physically larger in diameter and length, the number, size and thickness of the elastomeric layers may be varied to accommodate designs for different voltage levels. For example, 3-layer, 5-layer and 7-layer seismic dampeners may be designed for insulators ranging from the low tens of kV (e.g., 15 kV) to the high hundreds of kV (e.g., 765 kV) to cover the operating ranges of distribution and transmission disconnect switches, circuit breakers and bus insulators utilized in various service areas in the United States and other jurisdictions.

The type of equipment load supported by the insulator with a seismic dampener is not a feature of the invention. Nevertheless, it will be appreciated that a variety of heavy substation equipment is ordinarily supported by long insulators, such as disconnect switches, circuit breakers, bus insulators, capacitor banks, arrestors, etc. The innovative seismic dampener may therefore be installed in the insulator structure supporting any of these equipment loads.

Different arrangements of fasteners or cavities can be used to constrain the elastomeric layers, so they remain active for multiple operations without replacement over time. The elevated dampener serves as a flexible hinge absorbing seismic energy and allowing the insulator to deflect with respect to the stand, which is an effective solution making the system more reliable with lower costs and improved system reliability. This type of seismic dampener is small, inexpensive, and remarkably effective in providing seismic dampening for insulators for all potential modes of seismic shaking.

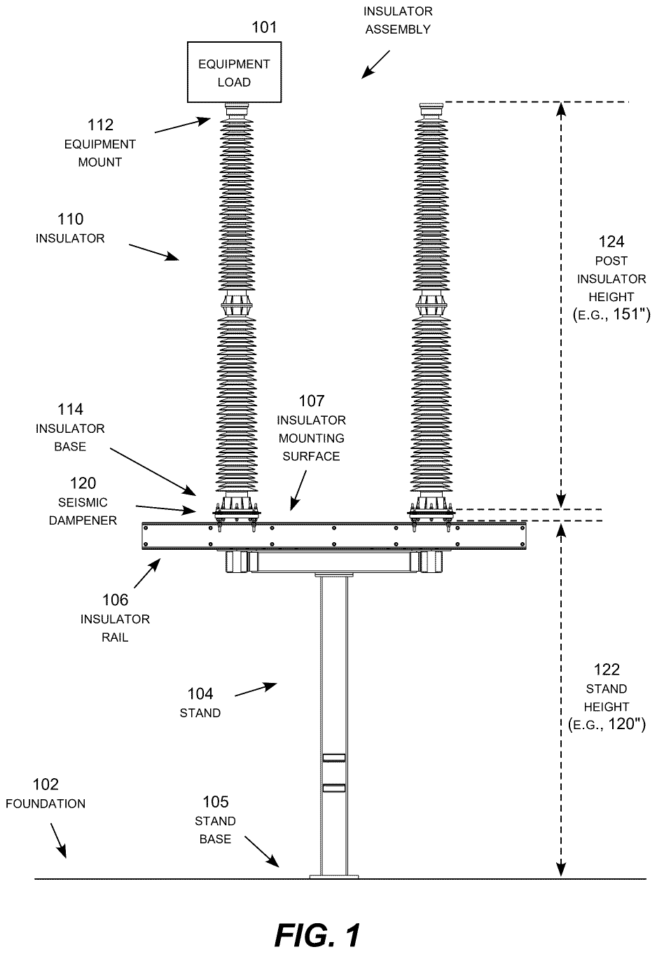

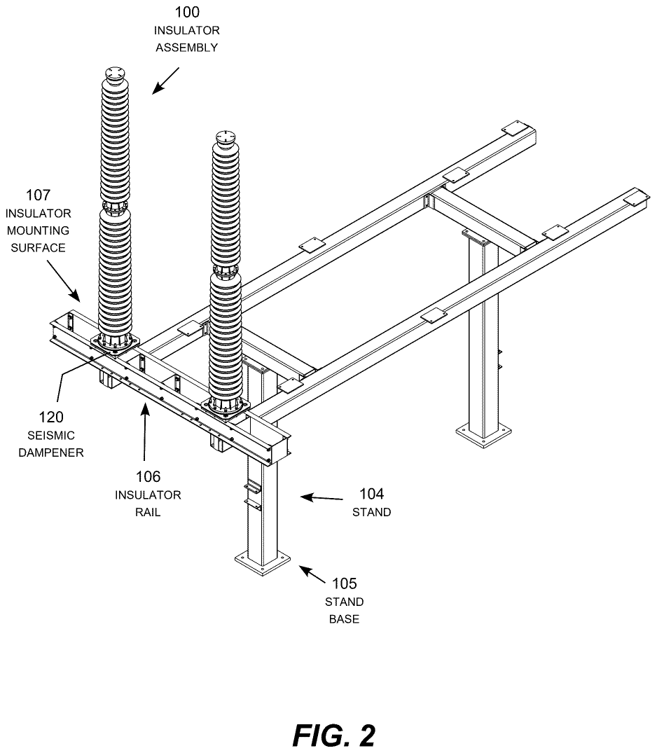

FIG. 1 is a front view and FIG. 2 is a perspective view of an insulator assembly 100, which supports an equipment load 101 above a foundation 102, typically a concrete equipment foundation formed on the physical ground. The assembly 100 includes a stand 104 extending vertically from a stand base 105 to an elevated insulator rail 106. The top side of the insulator rail defines an insulator mounting surface 107. An insulator 110 extends vertically from an insulator base 114 to an equipment mount 112, which is attached to the equipment load 101. An insulator dampener 120 is attached between the elevated insulator mounting surface 107 and the insulator base 114. While the stand base 105 is attached to the foundation 102, the insulator dampener 120 is significantly elevated with respect to the foundation. In general, the height 122 of the stand 104 at the location of the insulator mounting surface 107 is at least one-half the height 124 of the insulator 110. For this particular example, the height 122 of the stand 104 at the location of the insulator mounting surface 107 is about 80% of the height 124 of the insulator 110.

It will be understood that insulator assemblies have a wide range of sizes depending on the rated voltage of the electric equipment attached to the assembly. The specific embodiment shown in FIG. 1 is therefore merely representative for the purpose of illustrating the principles of the invention. The specific example shown in FIG. 1 is suitable for supporting a 550 kV disconnect switch in which the insulator 110 is about 151 inches long. In this particular example, the stand 104 is about 80% of the height of the insulator, or 120 inches. The seismic dampener 120 is only a few inches thick and located at the elevated insulator mounting surface 107 on top side of the insulator rail 106.

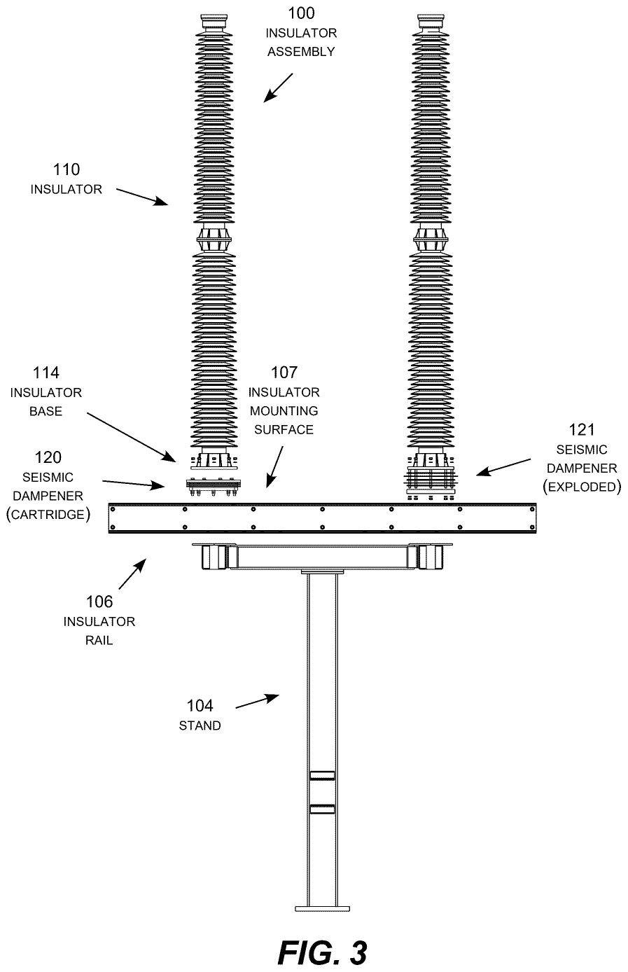

FIG. 3 is a partially exploded view of the insulator assembly 100, in which the seismic damper 120 is shown as an integrated cartridge configured for convenient installation between the insulator base 114 and the insulator mounting surface 107 at the time of insulator installation or retrofit. The cartridge configuration allows the dampener 120 to be assembled off site prior to installation in the field. Nevertheless, the seismic dampener 120 can be assembled on site when the insulator 100 is installed, if desired. FIG. 3 also shows an exploded view of an additional seismic dampener 121.

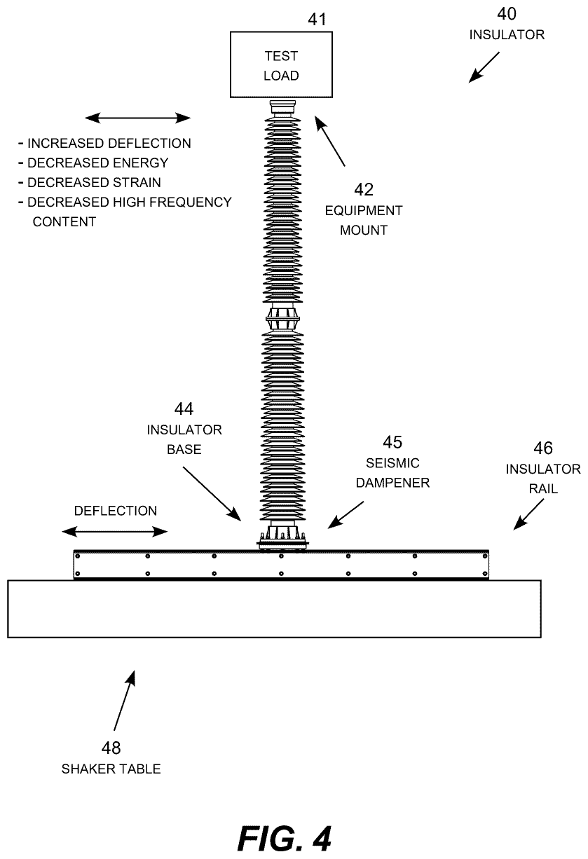

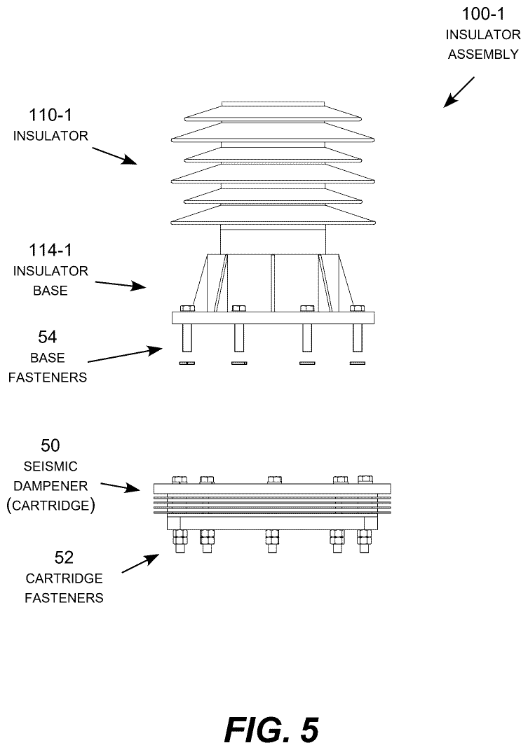

FIG. 4 is a conceptual illustration of shaker table testing of an insulator 40. A test load 41 simulating a typical equipment load is attached to the equipment mount 42 at the top of the insulator. The insulator base 44 is connected to a seismic dampener 45, which is attached to the insulator rail 46 which, in turn, is attached to the shaker table 48. A 5-layer seismic dampener substantially as described below with reference to FIGS. 5-8 was utilized for testing purposes. Shake testing was performed with and without the seismic dampener 45 to determine the effectiveness of the dampener on a variety of measured parameters. The shaker table 48 imparts single axis shaking to simulate seismic shaking. Generally described, the test results indicate that the seismic dampener 45 increases the natural harmonic frequency of the insulator structure, and increases the deflection at the test load, while decreasing the energy and strain on the insulator compared to an assembly without a dampener. Cantilever load versus stress testing produced a 38% reduction in the stress factor (strain per unit load) imposed on the insulator 100 compared to an assembly without a dampener. In other words, the relatively small and inexpensive 5-layer seismic dampener positioned inline with the insulator increases the load carrying capacity of the insulator by 38% under similar shake testing. Because the seismic dampener is horizontally symmetric about multiple axes and inserted inline with the insulator, this improvement applies to all potential seismic modes without altering the insulator itself or adding expensive hydraulic, pneumatic or spring dampeners for multiple potential shaking modes. This is a remarkable result for a relatively small dampener only a few inches thick.

In addition to reducing the cantilever stress on the insulator from ground shaking, the seismic dampener also decreases seismic stressors which are known to fracture the concrete at the porcelain-to-cap connection points of the insulator. These stressors can also damage other system components, such as hardware, bearings, casings, and the like. Reducing these stressors of the ground shaking may therefore allow the dampened insulator to withstand multiple seismic events, where an undampened insulator would fail during the first seismic event.

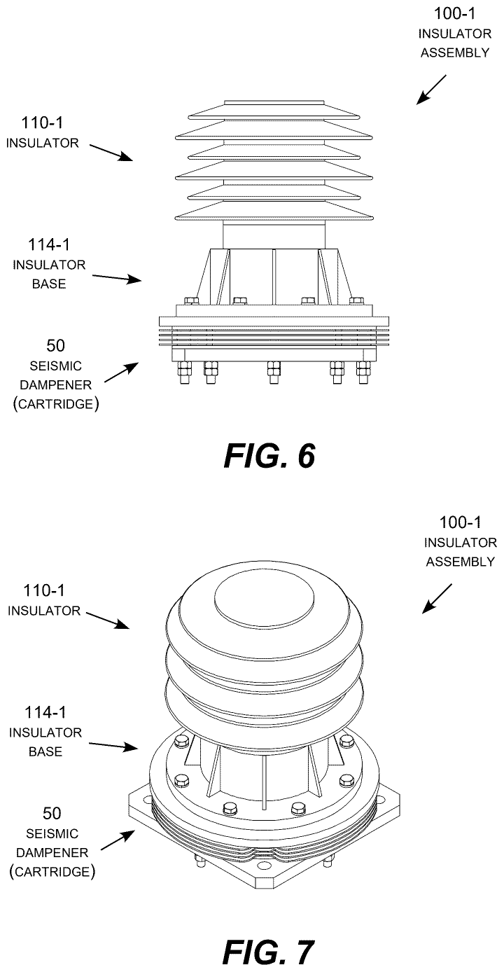

FIGS. 5-8 illustrate a portion of an example insulator assembly 100-1 including a first example seismic dampener 50, which includes five elastomeric layers (i.e., a 5-layer seismic dampener). FIG. 5 is a partially exploded view in which the seismic dampener 50 is configured as a pre-assembled cartridge for convenient installation inline with insulator 110-1 at an elevated position between the insulator base 114-1 and the insulator mounting surface on a stand. Cartridge fasteners 52 hold the layers of the seismic dampener 50 together, while base fasteners 54 secure the seismic dampener between the insulator base 114-1 and the insulator mounting surface. FIG. 6 is a front view and FIG. 7 is a perspective view showing the seismic dampener 50 attached to the insulator base 114-1.

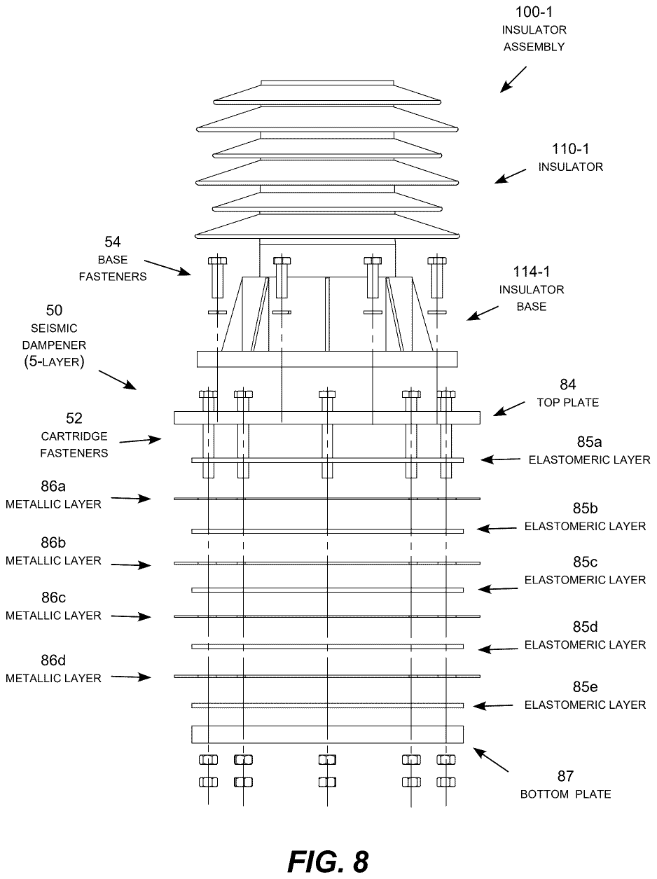

FIG. 8 is an exploded view showing the layer structure of the 5-layer seismic dampener 50, which includes an alternating series of five elastomeric layers 85a-85e and four metallic layers 86a-86d sandwiched between a top plate 84 and a bottom plate 87. In a representative embodiment, the top plate 84 may be about ¾-inch galvanized steel plate, each elastomeric layer 85a-85e may be about ¼-inch EPDM rubber, each metallic layer 86a-86d may be about ⅛-inch stainless steel, and the bottom plate 87 may be about 1-inch galvanized steel.

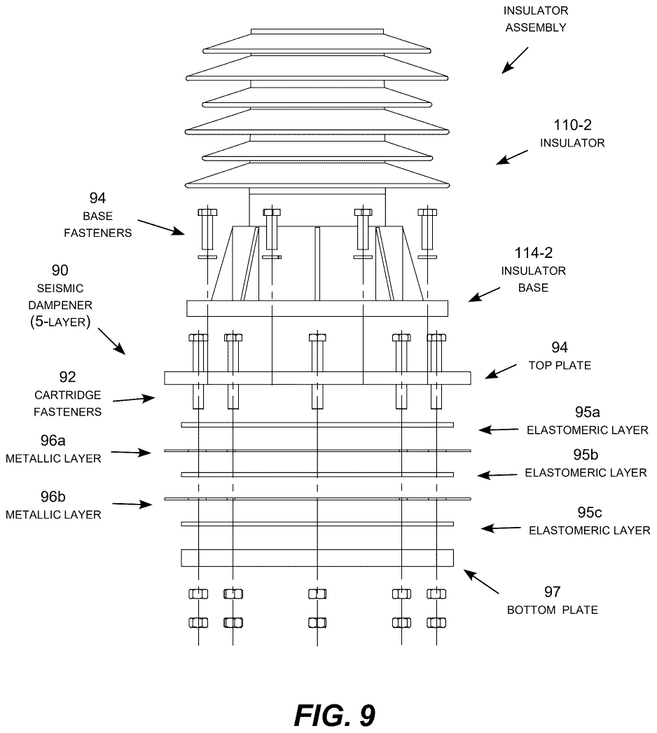

FIGS. 9-11 illustrate a portion of a second example insulator assembly 100-2 including a second example seismic dampener 90, which includes three elastomeric layers (i.e., a 3-layer seismic dampener). Other example seismic dampeners may be fabricated by varying the number of elastomeric layers, the thickness of the elastomeric layers, the durometer of the elastomeric layers, and variation of other parameters. The seismic dampener 90 may be configured as a pre-assembled cartridge for convenient installation inline with insulator 110-2 between the insulator base 114-2 of the insulator and the insulator mounting surface. Cartridge fasteners 92 hold the layers of the seismic dampener 50 together, while base fasteners 94 secure the seismic dampener between the insulator base 114-2 and the insulator mounting surface.

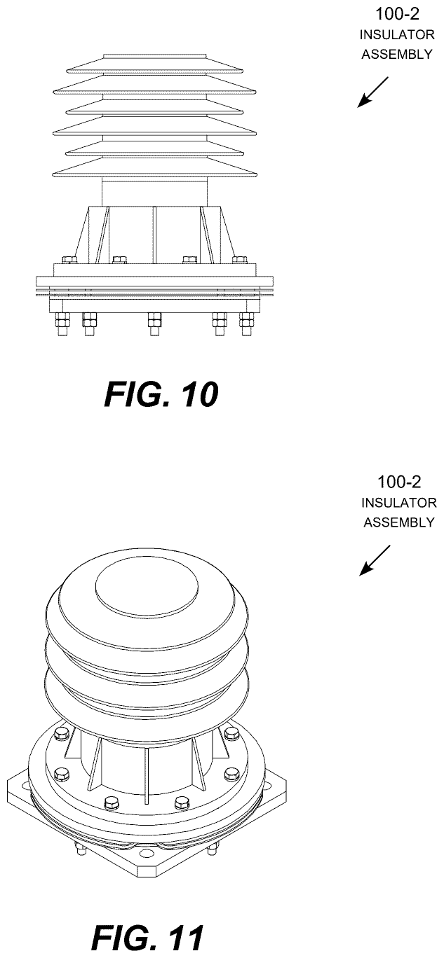

FIG. 9 is an exploded view showing the layer structure of an alternative 3-layer seismic dampener 90, which includes an alternating series of three elastomeric layers 95a-95c and two metallic layers 96a-96b sandwiched between a top plate 94 and a bottom plate 97. Again in this example embodiment, the top plate 94 may be about ¾-inch galvanized steel plate, each elastomeric layer 95a-95c may be about ¼-inch EPDM rubber, each metallic layer 96a-96b may be about ⅛-inch stainless steel, and the bottom plate 97 may be about 1-inch galvanized steel. FIG. 10 is a front view and FIG. 11 is a perspective view showing the assembled second example insulator assembly 100-2.

Another representative example is a 7-layer seismic dampener, similar to the 3-layer and 5-layer dampers except including an alternating series of seven elastomeric layers and six metallic layers sandwiched between the top and the bottom plate. While additional embodiments may include different numbers of layers, it appears that 3-layer, 5-layer and 7-layer embodiments will be adequate to cover the range of operating voltages presently in used in the Unites States and other jurisdictions. As previously noted, the diameter of the dampeners, as well as the number of layers, may vary for different voltage levels. The thickness of the elastomeric layers and their durometer may also be varied to obtain a desired seismic absorption performance, for example based on the weight and physical configuration of the equipment load. In addition, all of the elastomeric layers in a particular dampener may be, but need not necessarily be, the same thickness.

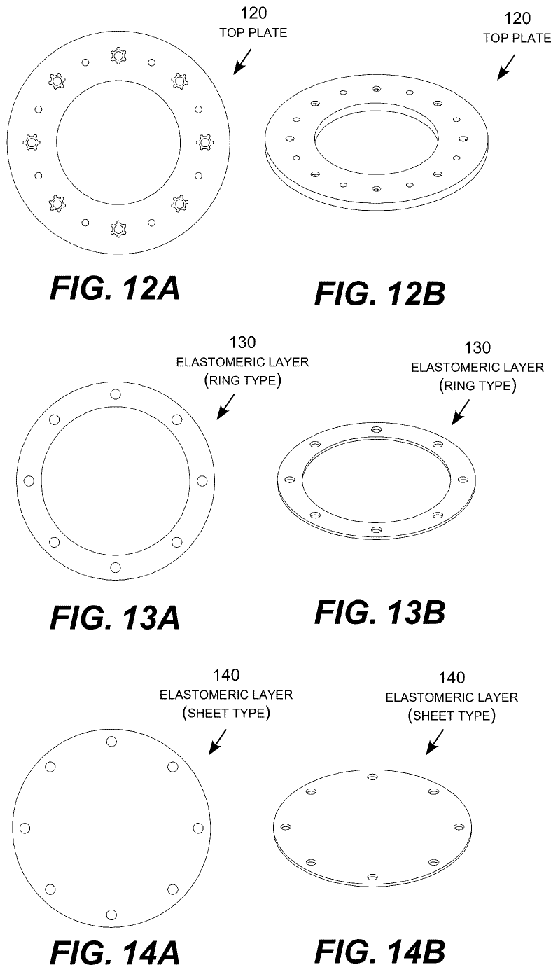

FIG. 12A is a top view of an example top plate 120 of a seismic dampener, and FIG. 12B is a perspective view of the example top plate.

FIG. 13A is a top view of an example ring-type elastomeric layer of a seismic dampener 130, and FIG. 13B is a perspective view of the example ring-type elastomeric layer.

FIG. 14A is a top view of an example sheet-type elastomeric layer 140 of a seismic dampener, and FIG. 14B is a perspective view of the example sheet-type elastomeric layer.

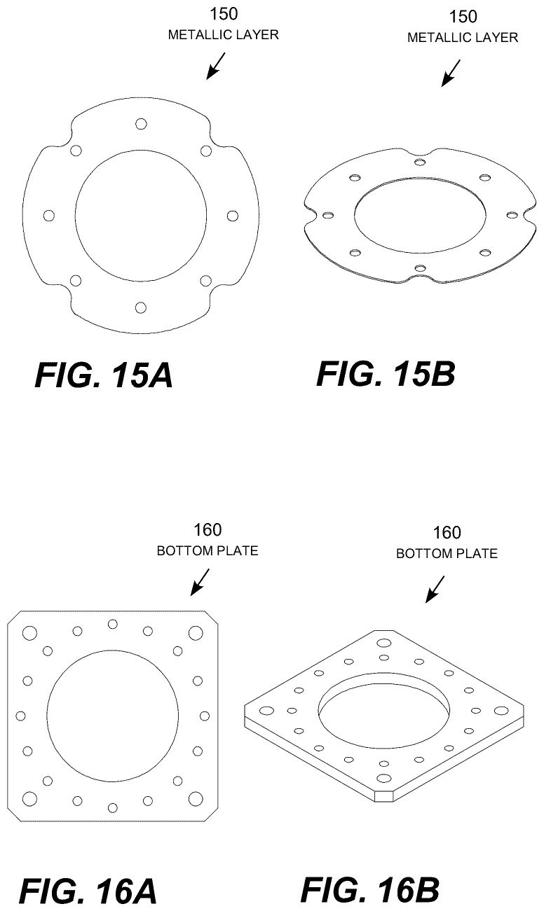

FIG. 15A is a top view of an example metallic layer 150 of a seismic dampener, and FIG. 15B is a perspective view of the example metallic layer.

FIG. 16A is a top view of an example bottom plate 160 of a seismic dampener, and FIG. 16B is a perspective view of the example bottom plate.

EPDM rubber is a good selection for the elastomeric (relatively low modulus) layers due to its high elasticity, allowing it to return to its original shape after deformation. It is also available with a suitable durometer for this purpose, durable, easy to work, and inexpensive. However, other suitable elastomeric materials existing today or developed in the future may be used as a matter of design choice. Similarly, stainless steel is a good selection for the metallic (relatively high modulus) layers due to its hardness, resistance to corrosion, available in thin layers, and low cost. However, other suitable relative high modulus materials existing today or developed in the future may be used as a matter of design choice.

It should be noted that the representative top plate 120, elastomeric layer 130 and 140, metal layer 150, and bottom plate 160 are all horizontally symmetric about multiple axes when installed inline with the insulator. This is an important design feature allowing the seismic dampener to respond equivalently to all potential modes of seismic shaking when installed inline with the insulator. It will be appreciated the size, thickness of the layers, and number of layers may be varied to accommodate different operating voltages, and thus physical sizes, of the insulators. In addition, the size, shape, thickness, hole patterns, and specific materials of these layers may be varied as a matter of design choice.

The foregoing relates only to the exemplary embodiments of the present invention, and numerous changes may be made therein without departing from the spirit and scope of the invention as defined by the following claims.

The invention claimed is:

1. A seismic dampener comprising:
a top plate;
a bottom plate;
an alternating series of relatively high modulus layers and relatively low modulus layers compressed between the top plate and the bottom plate.

2. The seismic dampener of claim 1, further comprising fasteners attaching the top plate, the bottom plate, and the alternating series of relatively high modulus layers and relatively low modulus layers into an integrated cartridge.

3. The seismic dampener of claim 1, located inline with an insulator supporting an equipment load between a base of the insulator and an elevated insulator mounting surface of a stand supporting the insulator.

4. The seismic dampener of claim 3, wherein the insulator has a height, and the seismic dampener is located at a height at least one-half the height of the insulator.

5. The seismic dampener of claim 1, wherein each relatively low modulus layer comprises ethylene propylene diene monomer (EPDM) rubber.

6. The seismic dampener of claim 1, wherein each relatively low modulus layer is about ¼-inch thick.

7. The seismic dampener of claim 1, wherein each relatively high modulus layer comprises stainless steel.

8. The seismic dampener of claim 1, wherein each relatively high modulus layer is about ⅛-inch thick.

9. The seismic dampener of claim 1, comprising three relatively low modulus layers, five relatively low modulus layers, or seven relatively low modulus layers.

10. A seismic dampened high voltage insulator assembly, comprising:
an insulator comprising an equipment mount on an upper end of the insulator supporting an equipment load, the insulator further comprising a lower end comprising an insulator base;
a stand supporting the insulator extending from a foundation to an insulator mounting surface;
a seismic dampener located inline with the insulator between the insulator base and the insulator mounting surface.

11. The seismic dampened high voltage insulator assembly of claim 10, wherein the insulator has a height, and the seismic dampener is located at a height at least one-half the height of the insulator.

12. The seismic dampened high voltage insulator assembly of claim 10, further comprising:
a top plate;
a bottom plate;
an alternating series of relatively high modulus layers and relatively low modulus layers compressed between the top plate and the bottom plate.

13. The seismic dampened high voltage insulator assembly of claim 10, further comprising fasteners attaching the alternating series of relatively high modulus layers and relatively low modulus layers between the top plate and the bottom plate into an integrated cartridge.

14. The seismic dampened high voltage insulator assembly of claim 10, wherein each relatively low modulus layer comprises ethylene propylene diene monomer (EPDM) rubber.

15. The seismic dampened high voltage insulator assembly of claim 10, wherein each relatively low modulus layer is about ¼-inch thick.

16. The seismic dampened high voltage insulator assembly of claim 10, wherein each relatively high modulus layer comprises stainless steel about ⅛-inch thick.

17. A seismic dampened high voltage insulator assembly, comprising:
an insulator comprising an equipment mount on an upper end of the insulator supporting an equipment load, the insulator further comprising a lower end comprising an insulator base;
a stand supporting the insulator extending from a foundation to an insulator mounting surface;
a seismic dampener located inline with the insulator supporting an equipment load between the insulator base and the insulator mounting surface comprising an alternating series of relatively high modulus layers and relatively low modulus layers compressed between a top plate and a bottom plate.

18. The seismic dampened high voltage insulator assembly of claim 17, wherein the insulator has a height, and the seismic dampener is located at a height at least one-half the height of the insulator.

19. The seismic dampened high voltage insulator assembly of claim 17, wherein each relatively low modulus layer comprises ethylene propylene diene monomer (EPDM) rubber.

20. The seismic dampened high voltage insulator assembly of claim 17, wherein each relatively high modulus layer comprises stainless steel.
